(19) United States
(12) Patent Application Publication
(10) Pub. No.: US 2005/0217153 A1
(43) Pub. Date: Oct. 6, 2005

(54) Hanging greeting card with gift/care package container

(76) Inventor: John Wilmer Ward II, Huntsville, AL (US)

Correspondence Address: JOHN W. WARD II, 1210 SE WILMINGTON RD, HUNTSVILLE, AL, 35803, US

(21) Appl. No.: 10/818,539

(22) Filed: Apr. 5, 2004

(51) Int. Cl. G09F 1/00

(52) U.S. Cl. 40/124.06

(57) ABSTRACT

A rectangular shape greeting card assembled from a flat sheet of paper, card-stock, cardboard or plastic with a hole, slit or both at the top for hanging and a gift/care package container at the bottom for a gift of any sort that can be hung from any bar, pole, rod, hook, knob or protrusion of any kind or it can be made through the process of injection molding with plastic.

### BACKGROUND OF THE INVENTION

1. Technical Field

This invention is in the area and relates to cards in general, but is more geared to self made custom greeting cards to fit any occasion.

2. Description of Related Art

Greeting cards are used to express many different feelings, thoughts and emotions of many kinds for many occasions. The feelings, thoughts and emotions can express love, congratulations, sorrow, happiness and many others. Different themes that can be put on the cards, but not limited to are: birthdays, weddings, holidays, anniversaries, graduations, birth of a baby or any other occasion that one might want to celebrate.

Currently most greeting cards are mass produced and have predetermined pictures and themes or messages so not to be exactly what you are looking to say or show in the art work.

Today with the mass production and commercialization of greeting cards, people often receive duplicate cards, which sometimes takes the meaning or sentiment away from the recipient as being special or personal in nature, as well as for the sender.

Greeting cards sometimes are used to send a gift such as a drawing, pictures, money or anything that can fit into the envelope, which limits the type of gift you can send to someone being flat.

If a sender wants to send a greeting card with a gift, it requires the gift to fit in the card or be affixed to the card in some manner.

If the sender wants to deliver a card and gift themselves, someone would have to be at the place of delivery or it would be placed on the floor or ground in front of the door where it might not be seen, stepped on and damaged.

My invention is a personalized custom hanging greeting card and gift/care package container with a written greeting, with or without a picture or artwork. The greeting and artwork can be hand, machine or computer generated. It is cut or punched out of an outline drawn or perforated on a single sheet of paper, card-stock, cardboard or plastic that is built, constructed or formed into a three dimensional hanging greeting card and gift/care package that can be hung from any bar, pole, rod, hook, knob or protrusion of any kind or it can be made through the process of injection molding with plastic.

My invention will prevent the greeting card and gift from being separated, thus eliminating the possible confusion of which card and gift go together and who it is from.

My invention allows the sender to have the ability to create a personal greeting card both in words and pictures or drawing.

My invention greatly lessons the likelihood of a person receiving duplicate greeting cards.

My invention allows for a greeting to be placed on any surface of the greeting card.

My invention allows for a picture or artwork to be placed on any surface of the greeting card.

My invention can have a message or design about any theme, holiday, happening or special event custom designed by the sender.

My invention of a hanging greeting card allows the sender to convey any sentiment, feeling or thought in both words and pictures or artwork.

My invention of a hanging greeting card can be delivered from hand to hand or left hanging from a bar, pole, rod, hook, knob or protrusion so it does not have to be placed on the floor or ground, possibly being stepped on and destroyed.

### BRIEF SUMMARY OF THE INVENTION

My invention of a personalized custom made hanging greeting card and gift/care package container is most suitable to be left hanging from a doorknob where it is most likely to be seen by the recipient when reaching for the doorknob instead of it being left in front of the door on the floor or ground where it might not be seen and stepped on thus damaging the greeting card, gift/care package container and gift.

### BRIEF DESCRIPTION OF THE DRAWINGS

FIG. 1: shows the outline of three dimensional hanging greeting card and gift/care package container on a sheet of paper, card-stock, cardboard or plastic.

FIG. 2: shows a hand, machine or computer generated greeting and picture or artwork.

FIG. 3: shows greeting card cut or punch-out of paper, card-stock, cardboard or plastic sheet. Also shows fold lines.

FIG. 4: shows first fold in construction of greeting card.

FIG. 5: shows second and third folds done to greeting card.

FIG. 6: shows fourth fold performed on greeting card.

FIG. 7: shows fifth fold performed on greeting card.

FIG. 8: shows sixth fold performed on greeting card.

FIG. 9: shows tab tacked into slits on the large panel from the backside.

FIG. 10: shows a finished, assembled or a plastic injected molded card.

### DETAILED DESCRIPTION OF THE INVENTION

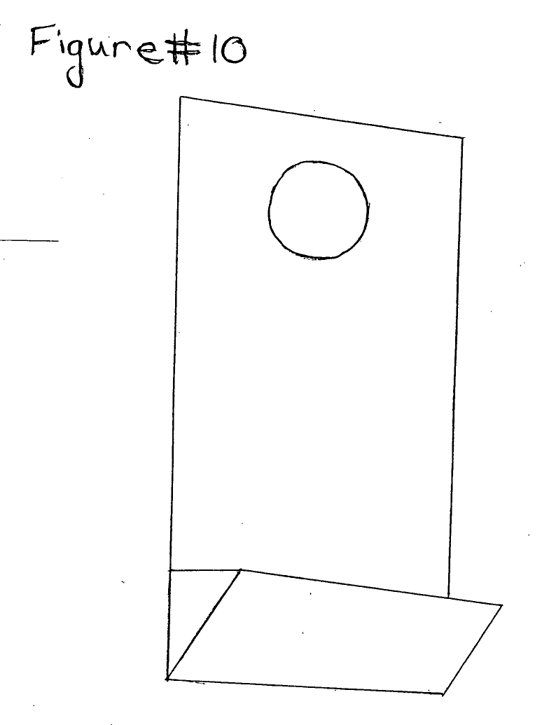

There are ten figures depicting the invention of this hanging greeting card and gift/care package container. These ten different figures show the greeting card in the form of a single flat sheet of paper, card-stock, cardboard or plastic to what it will look like when formed, constructed or built with FIG. 10 serving as what an injected plastic molded greeting card would look like. (Instructions are of the front, top and left side of gift/care package container; right side is a mirror Figure process of the left side.)

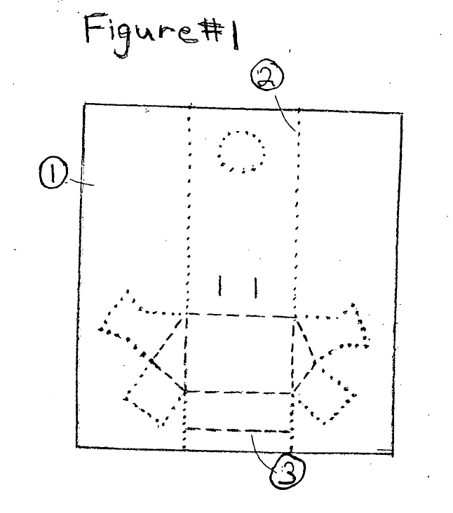

FIG. 1: shows the hanging greeting card as a flat sheet of paper, card-stock, cardboard or plastic sheet with a unique shape drawn in dotted and dashed lines. (1) is the sheet of paper, card-stock, cardboard, (2) are dotted lines that represent where it will be punched out of a perforated piece of paper, card-stock, cardboard or plastic. It can also represent a drawn line where it would be cut out with scissors, (3) is a dashed line where one will fold the unique shape to form the three dimensioned hanging greeting card and gift/care package container.

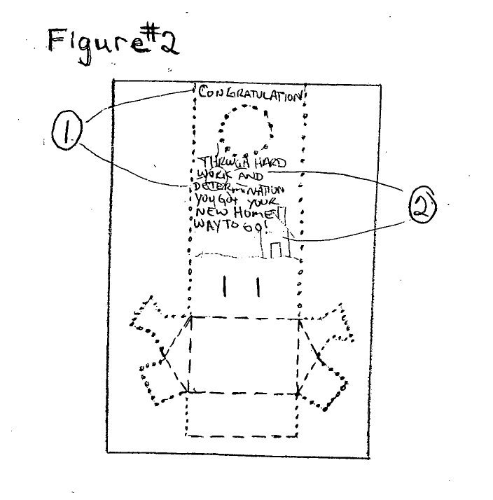

FIG. 2: shows a personal custom hand written, machine or computer generated greeting and a picture or artwork (1) is a greeting or message that can be generated by hand, machine or computer. (2) is a picture or artwork that can generated by hand, machine or computer.

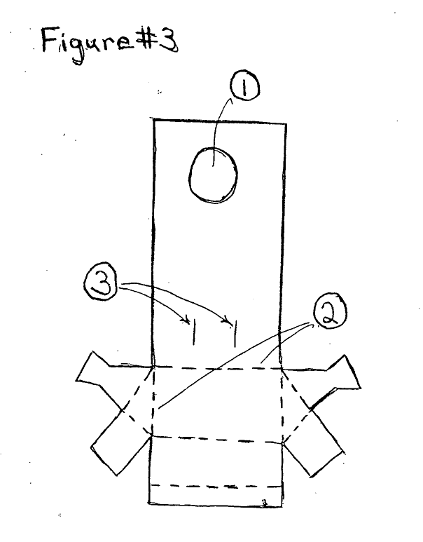

FIG. 3: shows the greeting card and gift/care package cut or punched out of paper, card-stock, cardboard or plastic sheet. (The greeting and artwork has been intentionally left off for clarity purpose of the diagram) (1) a hole in the top of the unique shape greeting card that was cut or punched out for the purpose of hanging the card. (2) dashed lines where the unique shape will be folded to form the three dimensional hanging greeting card and gift/care package container. (3) are two slits in the back panel of the card that will be used in conjunction with the tabs to “lock” the card into shape.

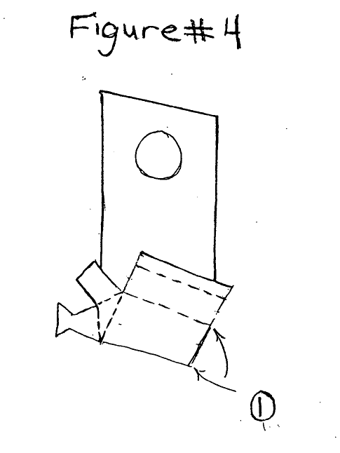

FIG. 4: shows the first fold performed in an upward direction, in constructing the three dimensional hanging greeting card and gift/care package container.

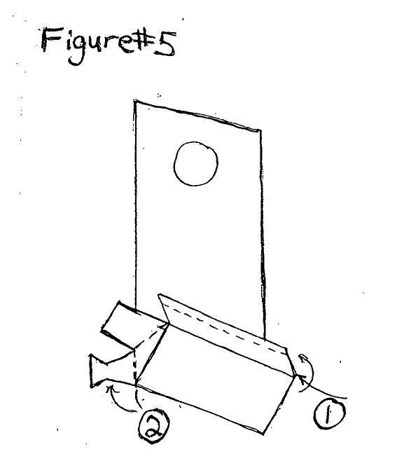

FIG. 5: shows (1) the second fold performed in an inward direction towards the large panel with the hole in it used for hanging the card, (2) shows the side panel being folded towards the large panel in a backwards direction.

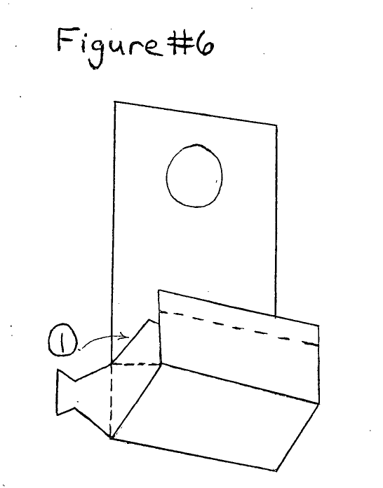

FIG. 6: show side panel, top flanges being folded down and inward in front of the large panel.

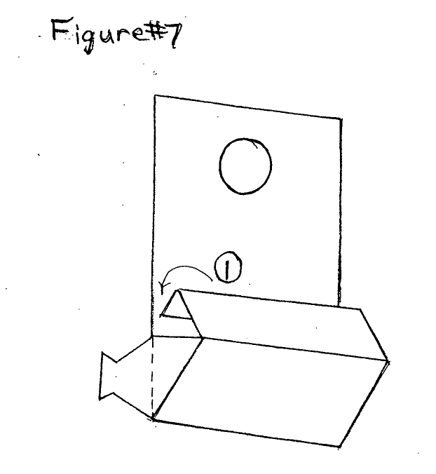

FIG. 7: shows the top edge of the front panel folded in and downward towards the large panel.

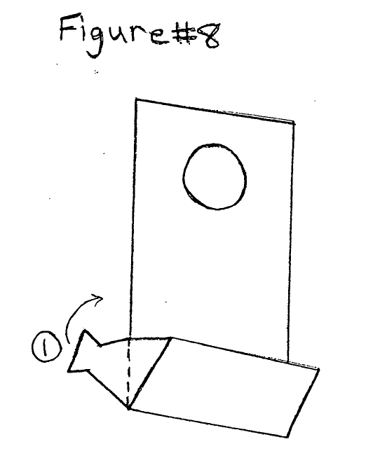

FIG. 8: shows the tab of the side panel is folded around to the backside of the large panel.

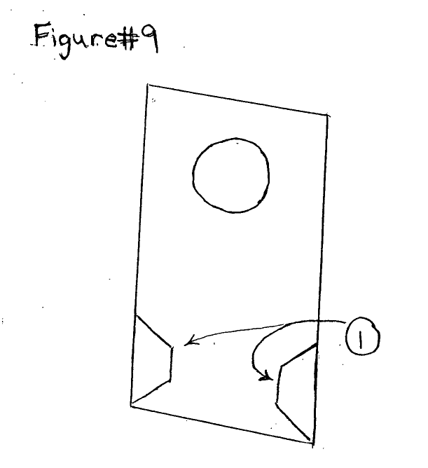

FIG. 9: shows the tabs that were folded around to the back of the large panel tucked into the slit that is in the large panel.

FIG. 10: shows completed form of the card.

It is understood that the aforementioned invention is a hanging greeting card and gift/care package container made from a single sheet of paper, card-stock, cardboard or plastic or can be made through the process of plastic injection molding and has no predetermined theme in words, picture or artwork, it should be recognized that invention is not limited to those specific materials. It should also be understood that any greeting, message, notice or writing can have any theme, happening, holiday or special event can be expressed by the sender as well as picture or artwork whether hand-written, machine or computer generated. It is also intended that the invention can by of any size and variation in shape.

1. A hanging greeting card with a gift/care package comprising of: a system for delivering messages, greetings, feelings or sentiments about any holiday, event or happening in hand-written or machine generated printed words with or without pictures, illustrations, drawings or artwork and a built-in or attached gift/care package container for placing a gift or present of any kind assembled from a flat sheet of paper, card-stock, cardboard or plastic to form a three dimensional greeting card and gift/care package, or it can be a plastic injection molded card.

2. The system of claim 1: said card has a front and back panel where a greeting can be hand-written or machine generated printing.

3. The system of claim 2: said card has a front and back panel where a drawing, picture or artwork can be handmade or machine generated.

4. The system of claim 3: said card has a front and back panel where a message and picture, drawing or artwork can be hand-written or machine generated.

5. The system of claim 4: said card is cut out or punched out from a sheet of paper, card-stock, cardboard or plastic sheet from a unique shape or form on the medium, or made through the process of plastic injection molding.

6. The system of claim 5: said card is formed, built or constructed by bending folds in said sheet card form and taping tabs to card surface panel or tucking tabs into slits in card surface panel.

7. The system of claim 6: said sheet card has a place to make a slit by cutting or punching out perforations at top end of the card for the purpose of hanging card on a bar, pole, rod, hook, knob or protrusion of any kind.

8. The system of claim 7: said card has a place to make a hole by cutting or punching out perforation at the top end of the card for the purpose of hanging card on bar, pole, rod, hook, knob or protrusion of any kind.

9. The system of claim 8: said card has a gift/care package container built from the unique card form or shape to hold or contain a gift, present or any other object.

10. The system of claim 9: gift/care package can be repeatedly opened and closed for means of placing or retreating a gift or present.

11. The system of claim 10: said gift/care package top can be removed or cut off to accommodate larger gifts or presents.

12. The system of claim 11: said greeting card message, greeting, pictures, artwork and drawings can be hand-created and/or machine or computer generated on any surface of card.

13. The system of claim 12: a hand-created, machine or computer-generated message/greeting can be done on any surface of the gift/care package container.

14. The system of claim 13: further included with greeting card and gift/care package sheet is a sheet with written and drawn instructions of how the greeting gift/care package container is built, formed or constructed from its sheet or paper, card-stock, cardboard or plastic. (This is not needed for the plastic injection molded card.)

15. The system of claim 14: further included is a computer program and or instructions to an existing computer program that can be used to design the greeting card and gift/care package.

16. The system of claim 15: said program included will have written and/or graphic capabilities.
